(19) United States
(12) Patent Application Publication
(10) Pub. No.: US 2005/0281335 A1
(43) Pub. Date: Dec. 22, 2005

(54) Apparatus and method for estimating hybrid block-based motion

(75) Inventor: Tae-hyeun Ha, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/153,347

(22) Filed: Jun. 16, 2005

(30) Foreign Application Priority Data
Jun. 16, 2004 (KR) 2004-0044342

(51) Int. Cl. H04N 11/04

(52) U.S. Cl. 375/240.16

(57) ABSTRACT

A method of estimating motion about a plurality of sub-blocks forming a frame, the method including selecting full search blocks of a predetermined number among the plurality of sub-blocks, and regarding the other sub-blocks excluding the full search blocks as fast search blocks; calculating a motion vector of the full search block by full search motion estimation algorithm; calculating a first motion vector of the fast search block by interpolation based on the calculated motion vector of the full search block; and calculating a second motion vector of the fast search block by fast search motion estimation algorithm, using a block position indicated by the first motion vector as a starting position. Thus the present invention provides an apparatus and a method for estimating motion, in which the amount of operation is reduced and matching block is more precisely searched as compared with fast search algorithm.

### CROSS-REFERENCE TO RELATED APPLICATION

This application claims priority from Korean Patent Application No. 2004-0044342, filed Jun. 16, 2004 in the Korean Intellectual Property Office, the disclosure of which is incorporated herein by reference.

### BACKGROUND OF THE INVENTION

1. Field of the Invention

The present invention relates to an apparatus and a method for estimating motion in order to compress a moving picture, and more particularly, to an apparatus and a method for estimating motion in a block by a full/fast search motion estimating algorithm and interpolation.

2. Description of the Related Art

A moving picture includes a temporal redundancy, a spatial redundancy, and a code redundancy by nature, so that compressibility of the moving picture can be improved by exploiting these redundancies. Generally, a motion estimation algorithm is used to eliminate the temporal redundancy; a discrete cosine transform (DCT) is used to eliminate the spatial redundancy; and variable length coding is used to eliminate probability correlation between codes.

As one of the motion estimation algorithms, a block-matching algorithm is adopted by most of standard moving picture compression methods such as H. 261/262/263, MPEG-1, MPEG-2, MPEG4, etc. The block-matching algorithm divides a current frame into several blocks (hereinafter, referred to as “reference blocks”), and searches a predetermined region (hereinafter, referred to as “search region”) of a prior frame for the most similar block (hereinafter, referred to as “matching block”) to a reference block, thereby calculating a motion vector of the searched block with respect to the reference block. Thus, only the motion vector and a pixel value difference between the reference block and the matching block are transmitted.

Here, a sum of squared difference (SSD), a sum of absolute difference (SAD), a mean absolute difference (MAD), a mean square error (MSE), etc. can be used in searching for ‘the most similar’ matching block to the reference block. Generally, the block-matching algorithm uses the SAD that can be realized by a simple hardware component without a multiplier. The SAD can be represented as the following equation (1).

$$\begin{matrix}SAD ( u , v ) = {\sum }_{i = 1}^{N} {\sum }_{j - 1}^{M} \vert R ( i , j ) - S ( i + u , j + v ) \vert , & - p \leq u , & v < p\end{matrix} \qquad ( 1 )$$

Where, N×M indicates the size of the reference block, R(ij) indicates a pixel positioned at an i^{th} line and a j^{th} row of the reference block, and S(ij) indicates a pixel positioned at an i^{th} line and an j^{th} row of the search region.

Here, the motion vector is defined by (u,v) coordinates of when SAD(u,v) has a minimum value, that is, by the following equation (2).
(u, v)=min{SAD(u, v)} (2)

Further, the block-matching algorithm is classified into a full search algorithm and a fast search algorithm.

The full search algorithm applies a SAD operation to the whole region of the search region in order to search the matching block to the reference block. The full search algorithm has a problem that the number of operations is increased as the size of the moving picture to be compressed is increased and the frame transmission speed is increased.

That is, when the motion vector that means allowable displacement within the search region corresponding to the reference block ranges from (−p) to (p−1) in both x- and y-axes as shown in FIG. 1, the SAD operation is performed 4p² times for applying the full search algorithm to one reference block.

Further, when the number of reference blocks included in one frame is n and the frame transmission speed of frame/sec is f, the SAD operation should be performed 4p²×n×f times every frame. Also, when the reference block comprises N×M pixels, subtraction, absolute-value operation and addition are performed 4p²×n×f×N×M times, respectively.

For example, when the full search algorithm is performed under the conditions that a screen comprises 720×480 pixels; the frame transmission speed is of 30 frame/sec; the reference block comprises 16×16 pixels; and the motion vector of a P-picture ranges from −32 to 31 in both the x- and y-axes, the subtraction, the absolute-value operation and the addition are performed 4.25×10¹⁰ times, respectively.

To complement the full search algorithm that has to perform the large amount of operations, there has been proposed the fast search algorithm. The fast search algorithm can be classified into a selective search algorithm and a pixel sub-sampling algorithm.

The selective search algorithm exploits that the number of SAD operations is proportionally increased according as the motion vector becomes apart from the matching block. In the selective search algorithm, several search positions are selected with respect to a predetermined starting position, and the SADs of the search positions are calculated. Then, the next search positions are selected with respect to the search positions having the minimum SAD. Such a selective search algorithm includes a three step search (TSS), a logarithmic search (LS), a conjugate search (CS), a diamond search (DS), a gradient search (GS), etc.

The pixel subsampling block matching algorithm uses some of the pixels included in the reference block for calculating the SADs on the assumption that all pixels are moved by the same distance, and compares the SADs with each other, thereby calculating the motion vector.

The fast search algorithm has an advantage that the amount of the operation is reduced because only some of blocks included in the search region or only some of pixels included in the reference block are compared. However, the foregoing assumption for the fast search algorithm is not always realized. That is, in the fast search algorithm, the motion vector is likely to be calculated corresponding to a local minima of the SAD not about the whole search region of the matching blocks but about the local search region thereof, so that performance thereof is degraded. At this time, if the fast search algorithm is applied to all search positions of the search region, it is hard to get into the local minima. However, even though the fast search algorithm is applied to all search positions of the search region, because only some of the pixels in the reference block are compared with each other, performance thereof is still degraded in the case where the reference block includes a horizontal or vertical linear image.

### SUMMARY OF THE INVENTION

Illustrative, non-limiting embodiments of the present invention overcome the above disadvantages and other disadvantages not described above. Also, the present invention is not required to overcome the disadvantages described above, and an illustrative, non-limiting embodiment of the present invention may not overcome any of the problems described above.

Accordingly, it is an aspect of the present invention to provide an apparatus and a method for estimating motion, in which the amount of operation is reduced and matching block is more precisely searched as compared with fast search algorithm.

The foregoing and/or other aspects of the present invention may be achieved by providing a method of estimating motion about a plurality of sub-blocks forming a frame, the method comprising selecting full search blocks of a predetermined number among the plurality of sub-blocks, and regarding the other sub-blocks excluding the full search blocks as fast search blocks; calculating a motion vector of the full search block by full search motion estimation algorithm; calculating a first motion vector of the fast search block by interpolation based on the calculated motion vector of the full search block; and calculating a second motion vector of the fast search block by fast search motion estimation algorithm, using a block position indicated by the first motion vector as a starting position.

According to an aspect of the present invention, the full search blocks are selected to be apart from each other.

The foregoing and/or other aspects of the present invention may be achieved by providing a method of estimating motion about a plurality of sub-blocks forming a frame, the method comprising applying full search motion estimation algorithm to sample blocks of a predetermined number selected among the plurality of sub-blocks, and calculating a motion vector of the sample block; and applying fast search motion estimation algorithm to the other sub-blocks excluding the sample blocks, and calculating the motion vector of the other sub-block excluding the sample blocks on the basis of a starting position being apart at a predetermined distance from a block position indicated by the motion vector of the adjacent sample block.

According to an aspect of the present invention, the distance is in proportion to a distance between the sub-block to which the fast search motion estimation algorithm is applied and the adjacent sample block.

According to an aspect of the present invention, the starting position includes the block position indicated by the motion vector of the other sub-blocks excluding the sample block, calculated by interpolation based on the motion vector of the sample block.

According to an aspect of the present invention, the sample blocks are selected to be apart from each other at a predetermined distance.

The foregoing and/or other aspects of the present invention may be achieved by providing a method of estimating motion about a plurality of sub-blocks forming a frame, the method comprising applying full search motion estimation algorithm to sample blocks of a predetermined number selected among the plurality of sub-blocks, and calculating a motion vector of the sample block; calculating a first motion vector of the other sub-blocks excluding the sample blocks by interpolation based on the motion vector of the sample block; and applying fast search motion estimation algorithm to the other sub-blocks excluding the sample blocks, and calculating a second motion vector of the other sub-blocks excluding the sample block on the basis of a block position indicated by the first motion vector.

The foregoing and/or other aspects of the present invention may be achieved by providing an apparatus comprising a first memory to store a first frame and a second memory to store a second frame, the apparatus comprising a sampling part to select sample blocks of a predetermined number among sub-blocks of the first frame; a full searching part to calculate a motion vector of the sample block selected by the sampling part by applying full search motion estimation algorithm to the sample blocks, regarding the second frame as a search region; an interpolation part to calculating a first motion vector of the other sub-blocks excluding the sample blocks by interpolation based on the motion vector of the sample block; and a fast searching part to calculate a second motion vector of the other sub-blocks excluding the sample blocks by applying fast search motion estimation algorithm to the sub-blocks excluding the sample blocks on the basis of a block position on the second frame indicated by the first motion vector.

The foregoing and/or other aspects of the present invention may be achieved by providing an apparatus comprising a first memory to store a first frame and a second memory to store a second frame, the apparatus comprising a precision searching part applying full search motion estimation algorithm to sample blocks of a predetermined number among sub-blocks of the first frame by regarding the second frame as a search region, and calculating a motion vector of the sample block; and a rapid searching part applying fast search motion estimation algorithm to the other sub-blocks excluding the sample blocks on the basis of a starting position being apart at a predetermined distance from a block position indicated by the motion vector of the adjacent sample block, and calculating a motion vector of the other sub-blocks excluding the sample blocks.

According to an aspect of the present invention, the starting position is selected on the basis of displacement between the sub-block to which the fast search motion estimation algorithm is applied and the adjacent sample block.

According to an aspect of the present invention, the rapid searching part comprises an interpolation part to calculate an estimation motion vector of the other sub-blocks excluding the sample blocks by interpolation based on the motion vector of the sample block, and to use a block position indicated by the estimation motion vector as a starting position.

According to an aspect of the present invention, the sample blocks are selected to be apart at a predetermined distance from each other.

According to an aspect of the present invention, the apparatus further comprises a frame delayer to delay the first frame to be stored as the second frame in the second memory.

### BRIEF DESCRIPTION OF THE DRAWINGS

The above and/or other aspects of the present invention will become apparent and more readily appreciated from the following description of the exemplary embodiments, taken in conjunction with the accompany drawings of which:

FIG. 1 is a view illustrating a reference block and a search region of a full search algorithm;

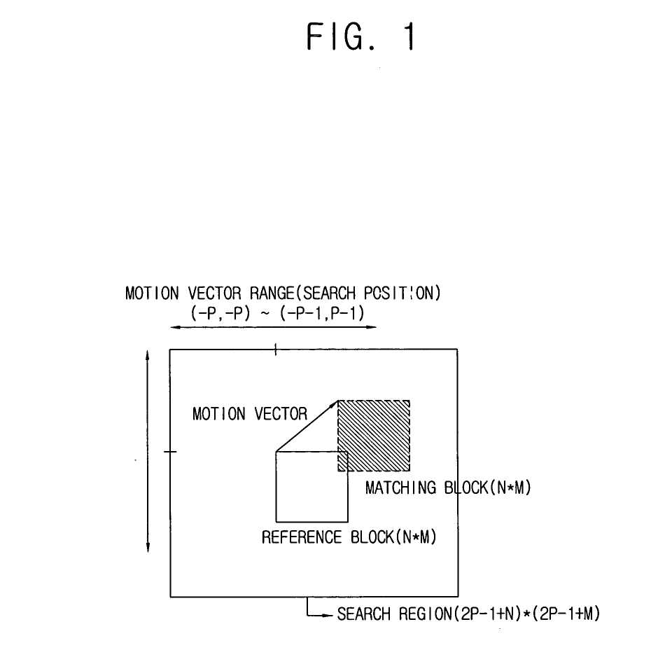

FIG. 2 is a block diagram of a motion estimation apparatus according to an exemplary embodiment of the present invention;

FIG. 3 is a flowchart of a motion estimation method according to an exemplary embodiment of the present invention;

FIG. 4 is a view illustrating an arrangement of sub-blocks forming a first frame, and the search region of a second frame; and

FIG. 5 is a view illustrating a motion vector field of a full search block according to the full search algorithm, and an estimated motion vector field of a fast search block according to interpolation.

### DETAILED DESCRIPTION OF EXEMPLARY EMBODIMENTS OF THE INVENTION

Reference will now be made in detail to the exemplary embodiments of the present invention, examples of which are illustrated in the accompanying drawings, wherein like reference numerals refer to like elements throughout. The exemplary embodiments are described below in order to explain the present invention by referring to the figures.

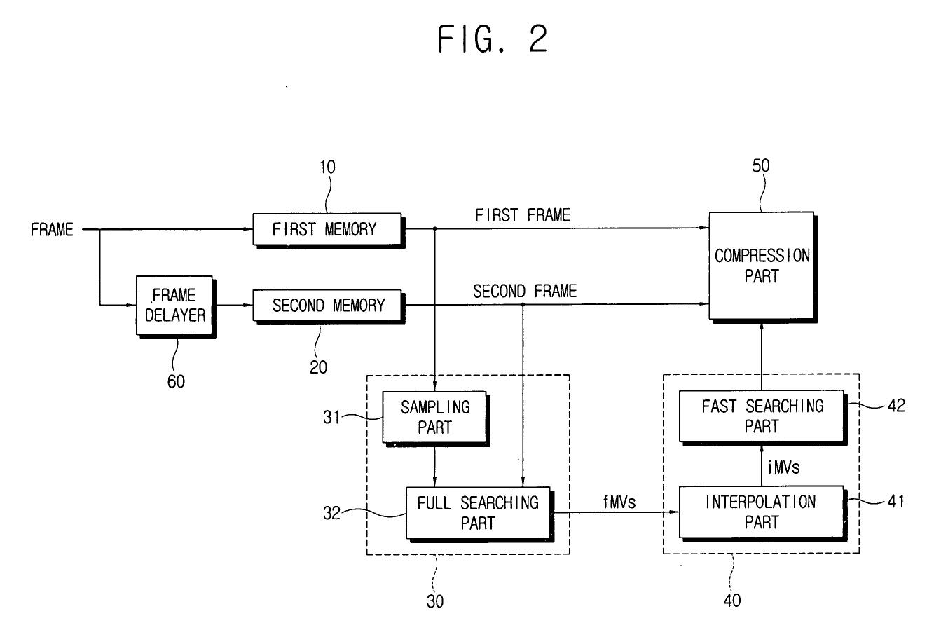

FIG. 2 is a block diagram of a motion estimation apparatus according to an exemplary embodiment of the present invention.

As shown in FIG. 2, the motion estimation apparatus comprises a first memory 10, a second memory 20, a precision searching part 30, a rapid searching part 40, and a compression part 50.

The first memory 10 stores a pixel value of a first frame to be compressed, and the second memory 20 stores the pixel value of a second frame offering a search region of sub-blocks forming the first frame. Here, the second frame may be a former frame to the current first frame. Therefore, the second memory 20 may further comprise a frame delayer 60 to delay the frame.

The precision searching part 30 applies a full search motion estimation method (hereinafter, referred to as “full search algorithm”) to sample blocks (hereinafter, referred to as “full search blocks”) of a predetermined number among the sub-blocks forming the first frame, thereby calculating a motion vector. Preferably, the full search blocks are spaced apart from each other and arranged at regular intervals.

The precision searching part 30 can comprise a sampling part 31 and a full searching part 32.

The sampling part 31 selectively samples the full search blocks of a predetermined number among the sub-blocks forming the first frame from the first memory 1.

The full searching part 32 uses at least one portion of the second frame from the second memory 20 as the search region, and calculates a motion vector by applying the full search algorithm to the full search blocks, thereby outputting the calculated motion vector to the rapid searching part 40.

The rapid searching part 40 applies a fast search motion estimation method (hereinafter, referred to as “fast search algorithm”) to the other sub-blocks (hereinafter, referred to as “fast search blocks”) excluding the full search blocks.

At this time, a “starting position” of the foregoing fast search block to which the fast search algorithm is applied is selected to be near to a block position indicated by the motion vector of the full search block adjacent to the corresponding fast search block.

A matching block of the fast search block adjacent to the full search block in which an optimum motion vector is calculated is likely to be near to the block position indicated by the motion vector of the full search block. Hence, the optimum matching block is rapidly searched when the fast search algorithm is applied to the full search block by employing the block position being near to the motion vector of the adjacent full search block as the starting position.

The starting position of the fast search algorithm can by set by applying displacement between the fast search block and the adjacent full search block to the motion vector of the full search block.

Alternatively, the motion vector of the adjacent fast search block can be estimated by employing interpolation on the basis of the motion vector of the full search blocks, thereby setting the motion vector as the starting position. That is, a first motion vector of the fast search block calculated by the interpolation is estimated on the basis of the matching block, so that the fast search algorithm can be applied by employing the estimated position as the starting position.

For this, the rapid searching part 40 comprises an interpolation part 41 and a fast searching part 42.

The interpolation part 41 applies the interpolation using the motion vector of the full search block calculated by the precision searching part 30, and estimates the first motion vector based on the matching block of the fast search block. Here, the interpolation may be classified into a nearest neighbor interpolation, bilinear interpolation, cubic convolution interpolation, B-spline interpolation, etc. according to the number of motion vectors of the fast search block.

The fast searching part 42 applies the fast search algorithm using the block position indicated by the first motion vector calculated by the interpolation part 41 as the starting position, thereby calculating a second motion vector.

Alternatively, the “starting position” can be selected as one of the block positions which is located a predetermined distance from the block position indicated by the motion vector of the full search block. Here, the predetermined distance is set in proportion to a distance between the fast search block and the adjacent full search block.

Referring to FIG. 2, the compression part 50 detects difference in a pixel value between the reference block and the matching block, and transmits the motion vector of all sub-blocks.

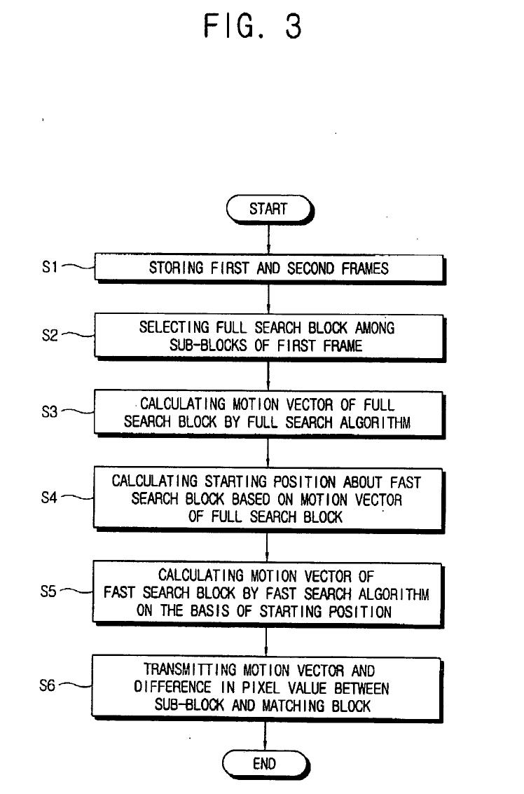

FIG. 3 is a flowchart of a motion estimation method according to an exemplary embodiment of the present invention.

Hereinbelow, operations of the motion estimation apparatus of FIG. 2 will be described with reference to FIG. 3.

First, when the second frame and the first frame are input in sequence, at operation S1, the first memory 10 stores the first frame and the second memory 20 stores the second frame delayed for a processing time of the first frame.

At operation S2, the sampling part 31 selects the full search blocks of a predetermined number among the plurality of sub-blocks forming the first frame, and outputs the selected full search blocks to the full searching part 32.

At operation S3, the full searching part 32 calculates the motion vector indicating the matching block of each full search block by applying the full search algorithm to the search region of the second frame from the second memory 20.

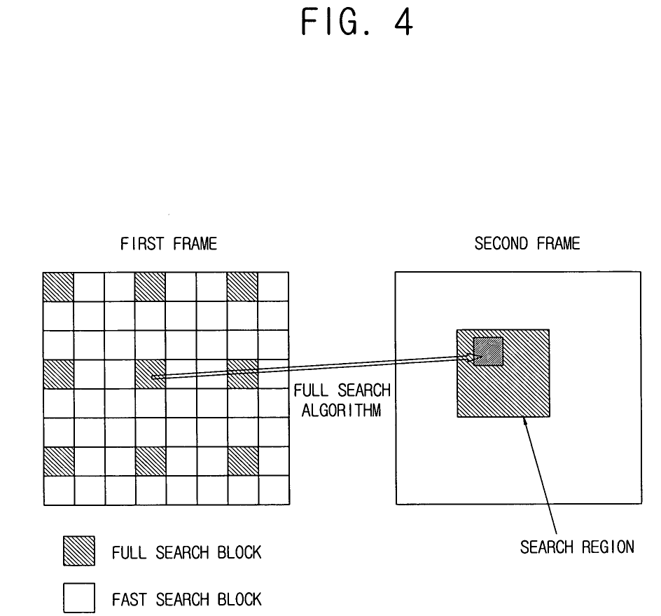

FIG. 4 is a view illustrating an arrangement of sub-blocks forming a first frame, and the search region of a second frame.

Referring to FIG. 4, the full search blocks are selected by the sampling part 31 to be arranged at regular intervals. Here, when the number of full search blocks is increased, the number of sub-blocks having the optimum matching block is increased, but the amount of operation is increased. Therefore, the number of blocks should be properly determined in consideration of the amount of operation.

The second frame comprises the search region having a predetermined size. The size of the search region can expand into the entire second frame, but is preferably limited to a proper size in consideration of the amount of operation.

At operation S4, the interpolation part 41 estimates/calculates the first motion vector of the fast search block by using the interpolation based on the motion vector of the full search block.

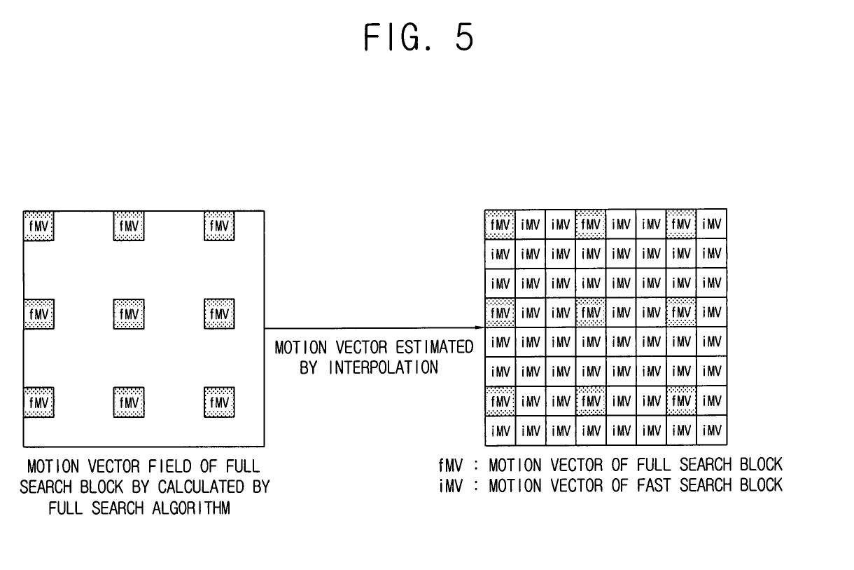

FIG. 5 is a view illustrating a motion vector field of a full search block according to the full search algorithm, and an estimated motion vector field of a fast search block according to interpolation.

Referring to FIG. 5, the full searching part 32 calculates the motion vector fMV of each full search block. Further, the interpolation part 41 estimates the motion vector iMV of the fast search block by employing the interpolation based on the motion vector fMV of the full search block.

At operation S5, the fast search part 42 applies the fast search algorithm to each fast search block by employing the block position indicated by the estimated motion vector of the fast search block as the starting position. Thus, the motion vector of each sub-block of the first frame is completely calculated and is output to the compression part 50.

At operation S6, the compression part 50 detects the difference in the pixel value between the sub-block and the matching block, and then outputs it together with the motion vector, thereby completing compression.

Thus, in the foregoing embodiment, the matching blocks are more precisely searched as compared with that of when one fast search algorithm is conventionally used. Therefore, even though the amount of operation can be increased by a little, the amount of operation is sharply decreased as compared with that of when one full search algorithm is conventionally used.

As described above, according to an embodiment of the present invention, the estimation of the matching block is sharply improved in precision with respect to the amount of operation.

Although a few embodiments of the present invention have been shown and described, it will be appreciated by those skilled in the art that changes may be made in these embodiments without departing from the principles and spirit of the invention, the scope of which is defined in the appended claims and their equivalents.

1. A method of estimating motion of a plurality of sub-blocks forming a frame, the method comprising:
selecting a predetermined number of the plurality of sub-blocks as a full search blocks, and selecting other sub-blocks of the plurality of sub-blocks, excluding the sub-blocks of the full search blocks as fast search blocks;
calculating a motion vector of a full search block by performing full search motion estimation algorithm;
calculating a first motion vector of a fast search block by interpolation based on the calculated motion vector of the full search block; and
calculating a second motion vector of the fast search block by performing a fast search motion estimation algorithm, using a block position indicated by the first motion vector as a starting position.

2. The method according to claim 1, wherein the full search blocks are selected to be non-adjacent to each other.

3. A method of estimating motion of a plurality of sub-blocks forming a frame, the method comprising:
applying a full search motion estimation algorithm to a predetermined number of sample blocks selected among the plurality of sub-blocks, and calculating a motion vector of each sample block; and
applying a fast search motion estimation algorithm to other sub-blocks of the plurality of sub-blocks excluding the sample blocks, and calculating a motion vector of each other sub-block on the basis of a starting position being located at a predetermined distance from a block position indicated by the motion vector of an adjacent sample block.

4. The method according to claim 3, wherein the predetermined distance is in proportion to a distance between the sub-block to which the fast search motion estimation algorithm is applied and the adjacent sample block.

5. The method according to claim 3, wherein the starting position includes the block position indicated by the motion vector of the other sub-block, calculated by interpolation based on the motion vector of the sample block.

6. The method according to claim 3, wherein the sample blocks are selected to be apart from each other by a predetermined distance.

7. A method of estimating motion of a plurality of sub-blocks forming a frame, the method comprising:
applying a full search motion estimation algorithm to a predetermined number of sample blocks selected among the plurality of sub-blocks, and calculating a motion vector of each sample block;
calculating a first motion vector of each of the other sub-blocks of the plurality of sub-blocks excluding the sample blocks by interpolation based on the motion vectors of the sample blocks; and
applying a fast search motion estimation algorithm to the other sub-blocks excluding the sample blocks, and calculating a second motion vector of each of the other sub-blocks excluding the sample blocks on the basis of a block position indicated by the first motion vector.

8. An apparatus comprising:
a first memory which stores a first frame and a second memory which stores a second frame;
a sampling part which selects a predetermined number of sub-blocks of the first frame as sample blocks;
a full searching part which calculates a motion vector of each sample block selected by the sampling part by applying a full search motion estimation algorithm to the sample blocks, regarding the second frame as a search region;
an interpolation part which calculates a first motion vector of each of the other sub-blocks of the plurality of sub-blocks excluding the sample blocks by interpolation based on the motion vector of the sample blocks; and
a fast searching part which calculates a second motion vector of each of the other sub-blocks excluding the sample blocks by applying a fast search motion estimation algorithm to each of the sub-blocks excluding the sample blocks on the basis of a block position in the second frame indicated by the first motion vector.

9. An apparatus comprising:
a first memory which stores a first frame and a second memory which stores a second frame;
a precision searching part which applies a full search motion estimation algorithm to a predetermined number of sample blocks of sub-blocks of the first frame by regarding the second frame as a search region, and calculates a motion vector of each of the sample blocks; and
a rapid searching part which applies a fast search motion estimation algorithm to each of the other sub-blocks of the plurality of sub-blocks excluding the sample blocks on the basis of a starting position located a predetermined distance from a block position indicated by the motion vector of an adjacent sample block, and calculating a motion vector of each of the other sub-blocks excluding the sample blocks.

10. The apparatus according to claim 9, wherein the starting position is selected on the basis of displacement between the sub-block to which the fast search motion estimation algorithm is applied and the adjacent sample block.

11. The apparatus according to claim 9, wherein the rapid searching part comprises an interpolation part to calculate an estimation motion vector of each of the other sub-blocks excluding the sample blocks by interpolation based on the motion vector of the sample blocks, and to use a block position indicated by the estimation motion vector as a starting position.

12. The apparatus according to claim 9, wherein the sample blocks are selected to be a predetermined distance apart from each other.

13. The apparatus according to claim 8, further comprising a frame delayer which delays the first frame to be stored as the second frame in the second memory.

14. The apparatus according to claim 9 further comprising a frame delayer which delays the first frame to be stored as the second frame in the second memory.
